(19) United States
(12) Patent Application Publication
(10) Pub. No.: US 2025/0200018 A1
(43) Pub. Date: Jun. 19, 2025

(54) DATA STRUCTURE CONTAINING IDENTIFIER FOR NUMERICAL DATA, AND NUMERICAL VALUE MANAGEMENT SYSTEM USING SAME

(71) Applicant: Laplace System Co., Ltd., Kyoto-shi, Kyoto (JP)

(72) Inventor: Masayuki HORII, Kyoto-shi, Kyoto (JP)

(21) Appl. No.: 18/846,915

(22) PCT Filed: Mar. 16, 2023
(86) PCT No.: PCT/JP2023/010235

§ 371 Date: Sep. 13, 2024

(30) Foreign Application Priority Data
Mar. 16, 2022 (JP) 2022-041086

(51) Int. Cl. G06F 16/22; G06F 9/54

(52) U.S. Cl. CPC G06F 16/2228; G06F 9/547

(57) ABSTRACT

A pair of logical data structures includes: a logical database in a database server in which numerical data including numerical values associated with a timestamp is recorded; and a data identification ID identifying an attribute of the numerical values. The data identification ID includes a unit ID, having a character string of at least two bytes defining a unit of the numerical data, and an item ID, of at least four bytes and made up of an item number constituted of an integer value of at least two bytes for defining a type ID of at least two bytes for defining a type of the numerical data and for identifying the type ID, and the type ID, the unit ID is associated with a name and a unit character string, and the type ID includes a character string corresponding to each type ID and the unit ID.

### TECHNICAL FIELD

The present invention relates to a data structure containing an identifier for numerical data and to a numerical value management system using the data structure.

### BACKGROUND ART

All digitized numerical data including numerical data acquired from a measuring instrument are given a meaning using a data table (referred to as a channel table in measurement). For example, FIG. 5A represents an example of a simple channel table. In this example, channel 1 is shown to be generated electric power with kW as a unit, channel 2 is shown to be temperature with ° C. as a unit, and channel 3 is shown to be solar radiation intensity with kW/m² as a unit.

Unlike a case of communicating through a plurality of paths, when transmitting and receiving a plurality of kinds of numerical data with a data communication apparatus using one path, not only a value of the data being sent but an order of the data has an important meaning on a receiving side. A protocol specification is a table showing what a piece of data received at a certain order means to the receiving side and is set in advance at a transmission source.

Patent Literature 1 discloses a method of transferring data from a sensor by adding information such as a unit of measurement, a system, and an error to a message header when encoding a sensor signal. Patent Literature 2 discloses, regarding a control method of wireless communication for a photovoltaic power generation system, a method of identifying data on an accumulated generated power amount and the like by adding identification information of the photovoltaic power generation system to a part of communication data sent between a transmitter and a receiver.

### CITATION LIST

### Patent Literature

Patent Literature 1: Japanese Patent Laid-Open No. 2011-520309
Patent Literature 2: Japanese Patent Laid-Open No. 2006-277383
Patent Literature 3: Japanese Translation of PCT International Application Publication No. 2017-530671

### SUMMARY OF INVENTION

### Technical Problem

In reality, there are various kinds of both data tables for digital data and communication protocols for communication data and no unified standards are available. For example, with measuring instruments, a channel table included in a protocol specification differs from one measuring instrument to another. A communication protocol between a PCS (power conditioner) and a control terminal connected to the PCS in photovoltaic power generation systems also differs among manufacturers and among models.

For example, FIG. 5B shows an example of a channel table of a given PCS. The channel table shows, for each channel, contents of a physical quantity (for example, input voltage and input current), a data size (4 bytes or 6 bytes), a data format (a decimal point position or the like), a data range, remarks, and the like signified by data. The channel table is provided with more detailed annotations. Such annotations include setting a sign but not a decimal point, adopting system voltage as data No. 4 [output voltage (V)] upon stoppage of PCS, and adopting isolated output voltage as data No. 4 [output voltage (V)] during isolated operation of PCS (only when an isolated operation function is provided).

In addition, specifications described in such channel tables are frequently updated. Therefore, versions of a protocol specification must always be managed in order to prevent problems at an installation site of a measuring instrument.

Furthermore, channel numbers of measurement terminals are only unique inside each measurement terminal. If there are a plurality of measurement terminals in one power generation system, overlapping may occur among channel numbers. In other words, this problem is a problem caused by using a protocol specification which is used only locally and of which specifications are frequently updated and may be considered an essential problem for which drastic measures were not taken over a long time.

The present invention has been made in consideration of the above and an object thereof is to provide a novel data structure that enables a meaning of a numerical value and numerical data to be globally identified even when there is no protocol specification on a local side by enabling a protocol specification previously only locally usable to be globally uniquely usable.

### Solution to Problem

A data structure according to the present invention is a pair of logical data structures constituted of:
a logical database constructed in a database server in which numerical data including a plurality of numerical values associated with a timestamp is recorded; and
a data identification ID uniquely identifying an attribute of the numerical values constituting the numerical data, wherein the data identification ID includes:
   a unit ID constituted of a character string of at least two bytes defining a unit of the numerical data, and
   an item ID of at least four bytes and made up of an item number, the item number being constituted of an integer value of at least two bytes for defining a type ID of at least two bytes for defining a type of the numerical data and for uniquely identifying the type ID, and the type ID,
   the unit ID is associated with a name and a unit character string, and
   the type ID includes at least a character string corresponding to each type ID and the unit ID.

In the configuration described above, the unit ID may be further associated with a prefix to be attached to a unit.

In the configuration described above, the data identification ID can be configured such that
by recording the data identification ID in an ID management server being physically or logically separated from the database and
by performing, via middleware, new registration of a plurality of numerical values associated with an updated timestamp or reading of an arbitrary numerical value recorded in the database,
the data identification ID and each numerical value included in the plurality of pieces of numerical data associated with the data identification ID are always handled as a pair of data.

In the configuration described above, the middleware may be executed in a measuring apparatus for acquiring numerical data including a plurality of numerical values associated with the timestamp and
may be constructed by transmitting the data identification ID to the ID management server and transmitting the timestamp and the numerical data corresponding to the timestamp to the database server.

In the configuration described above, the middleware may be executed in a middleware server being physically or logically separated from the measuring apparatus and
may be constructed by transmitting the data identification ID to the ID management server and transmitting the timestamp and the numerical data corresponding to the timestamp to the database server.

In this case, a “middleware server” refers to a server for implementing data access middleware (hereinafter, sometimes referred to as “middleware”) that is a program and a server physically or logically separated from other servers.

A numerical value management system according to the present invention uses
the data structure according to any one of claims 3 to 5 including at least the ID management server, the database server, and the middleware interposed between the ID management server and the database server.

In the configuration described above, the middleware may be configured to act as a proxy of requests and replies to the database.

### Advantageous Effects of Invention

According to the present invention, by eliminating the need for a local side to prepare a data chart or a protocol specification for giving data meaning, the local side is freed from version management of protocols, on-site confusion is eliminated, and a contribution is made toward promoting further utilization of data.

### BRIEF DESCRIPTION OF DRAWINGS

FIG. 1 is a diagram showing a configuration example of a power generation system according to a first embodiment.

FIG. 2 is a table illustrating a list of physical unit IDs.

FIG. 3 is a table illustrating a list of physical type IDs.

FIG. 4 shows a format of an item ID.

FIG. 5A represents an example of a simple channel table. FIG. 5B shows an example of a channel table of a given PCS.

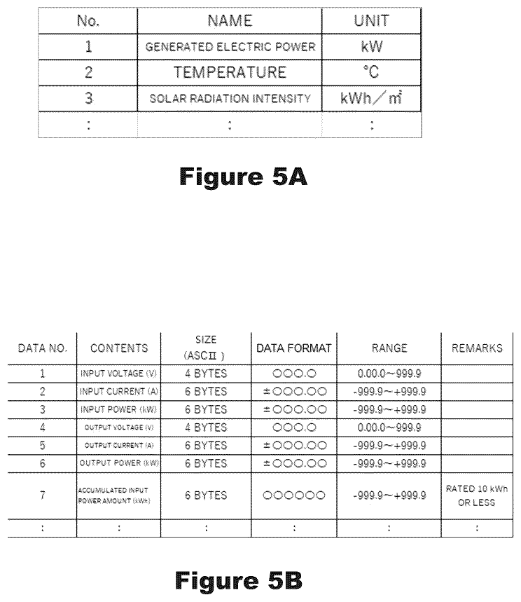

FIG. 6A is a configuration diagram of a case where data access middleware 102 is not arranged and a user directly accesses a measured data server 4 via a plurality of remote monitoring sites 1 to 3 and FIG. 6B is a configuration diagram of a case where the measured data server 4 is accessed via data access middleware.

### DESCRIPTION OF EMBODIMENTS

A basic concept of the present invention is to prepare, separately from a measurement database, a table (database) in which, with respect to all data (numerical value) handled in a same system or the numerical value, an identifier (defined as a “data identification ID” in the present specification) for uniquely identifying an accompanying unit or the like is associated, and centrally managing the data and the like using the prepared table. Hereinafter, details of the data identification ID will be described through each embodiment. While a numerical value representing a physical quantity is accompanied by a unit of each physical quantity, the numerical value is further accompanied by a unit prefix of decimals such as m (milli), μ (micro), and p (pico) and of large numbers such as k (kilo) and M (mega). Since these must also be uniquely identified, the unit prefixes will be handled as a type of numerical data and will be referred to as “data and the like” in the present specification.

### First Embodiment-Data Identification ID Applied to Physical Quantity

In the first embodiment, a data identification ID (physical quantity data identification ID) acquired mainly through a measuring instrument and to be applied to a physical quantity transmitted and received through digital communication.

### Data Identification ID

A data identification ID will now be described in greater detail.

For example, a data identification ID with respect to a physical quantity (hereinafter, referred to as a “physical quantity data identification ID”) is constituted of a. a physical unit ID and b. a physical type ID and all pieces of software possess both the physical unit ID and the physical type ID as files and refer to the physical unit ID and the physical type ID as necessary. Preferably, lists of physical unit IDs and physical type IDs are stored in a server and made so as to be always referable or downloadable through a telecommunication line such as the Internet.

a. Physical Unit ID

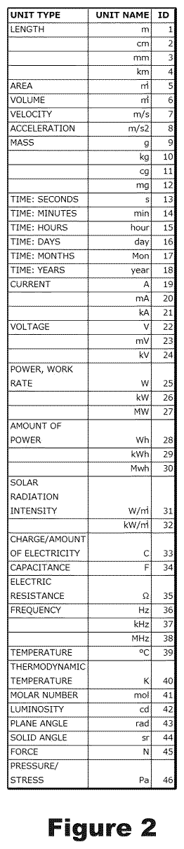

FIG. 2 is a table illustrating a list of physical unit IDs. A physical unit ID is a value that defines a physical unit and is common among all pieces of software. A physical unit ID has an ID, a name, and a unit character string as items. Even for a same unit, there is a physical unit ID for each unit prefix (m, k, G, M, and the like). For example, when representing electric power, not only the unit but the prefix is also important such as when distinguishing between 200 W and 200 kW. Since the number of types of physical unit IDs is not that large, physical unit IDs can be sufficiently represented by, for example, 2 bytes (65536 ways).

b. Physical Type ID

A physical type ID is a value for identifying a physical type or a type of role of data such as an amount of solar radiation, air temperature, DC power, or power conditioner (PCS) output power and a physical type ID is assigned to all physical quantities. A physical type ID is also assigned to calculated value such as indices and efficiencies. A physical type ID is also expressed by 2 bytes.

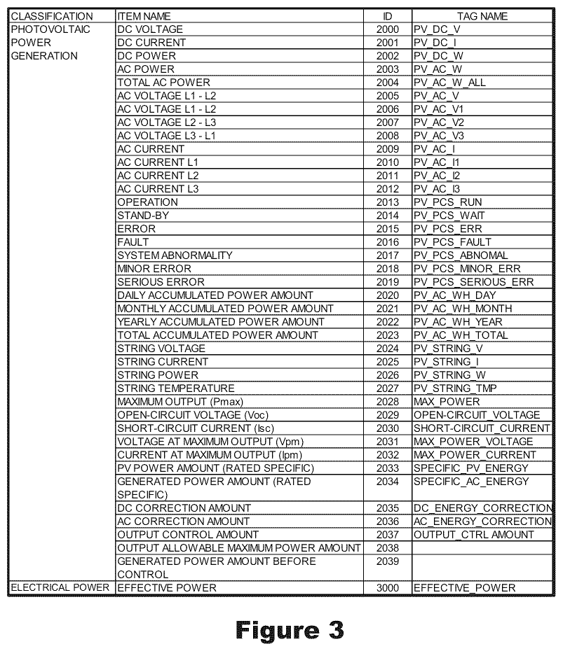

FIG. 3 is a table illustrating a list of physical type IDs. With respect to a large classification of photovoltaic power generation, a physical type ID is attached to physical quantities to be handled in a photovoltaic power generation system. An item name and a tag name are assigned to each physical type ID.

A name, a tag name, a variable name, a unit ID, a (unit character string), and the like are associated with a physical type ID, a physical type ID (ID) is defined as an integer value, and a physical type name (name) is defined as a character string.

While only a classification, an item name, an ID, and a tag name are described in FIG. 3, a unit ID is set for each physical type ID. For example, “V” is assigned to DC voltage and a unit ID is assigned with respect to “V”.

### Class Definition Example of Physical Type ID

class Tphysic ID {

int ID;//physical type ID

string name;//physical type name

int unit_ID//physical unit ID

string unit_name//unit name

void set() //according to physical unit ID, set physical type name, unit ID, and unit name.

};

As shown in FIG. 3, for example, ID=2000 and tag name: PV_DC_V are attached to DC voltage in a photovoltaic power generation system. In a similar manner, ID=2001 and tag name: PV_DC_1 are attached to DC current. In this manner, physical type IDs determined in advance enable all kinds of physical types to be defined.

ID=2000 tag name: PV_DC_V (meaning: DC voltage in photovoltaic power generation)

ID=2001 tag name: PV_DC_1 (meaning: DC current in photovoltaic power generation)

In consideration of cases where there are a plurality of systems of a unique physical type ID such as when a plurality of systems of measuring instruments exist at one measurement site (site), an “item ID” is defined by adding a 2-byte natural number starting with 1 to a 2-byte physical type ID. For example, even when there are a plurality of systems and a plurality of PCSs are connected to each system, numbers are allocated to all systems instead of allocating numbers from 1 to each system. Alternatively, when there are a plurality of physical type IDs to which a same physical type ID has been assigned such as an actinometer and a module temperature, the physical type IDs are to be made distinguishable by item IDs.

### Class Design Example

A class is an object in a program and, after first defining a “class of all calculation formulas” for controlling the whole, a “class of each calculation formula” is defined according to differences in calculation methods under the class of all calculation formulas. Accordingly, classes are divided into a “class of all calculation formulas” and a “class of each calculation formula” in a similar manner to channels.

A calculation formula means a calculation formula for calculation processing with respect to measured data (raw data). Data by the calculation formula is defined as calculation formula data to be handled separately from measured data.

class Tkeisanki {

int siki_su;

vevtor<Tsiki>siki;

void<Tsiki>siki;

void addEmptyVectorSiki (int siki_su);

};

class Tsiki {

Tkomoku_ID komoku_ID;//item ID class

A concept of an identification ID is applied to not only measured data but also data calculated using a specific calculation formula based on the measured data.

c. Item ID

An item ID is defined as a value that combines a physical type ID and an item number in case there are a plurality of physical type IDs. An item ID is to be identified as a unique value that never overlaps in a group of data (a measurement channel, a calculation formula, an input formula, and the like) of one site.

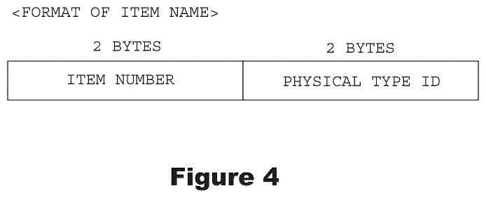

FIG. 4 shows a format of an item ID. As shown in FIG. 4, an item ID has a format combining an item number (2 bytes) and a physical type ID (2 bytes).

Item numbers are serial integer values starting from 1. 1 is used even when there are no plurality of same physical type IDs. Numbers do not overlap with each other at one site. For example, even when there are a plurality of systems and a plurality of PCSs are connected to each system, numbers are allocated to all systems instead of allocating numbers from 1 to each system. Furthermore, even if there are a plurality of measurement terminals and a plurality of measurement systems, numbers are similarly allocated so as not to overlap with each other. Alternatively, item numbers are used when there are a plurality of same physical type IDs such as a plurality of actinometers, a plurality of module temperatures, or the like.

*While all item IDs may conceivably be processed according to class as follows, item IDs are to be tentatively defined.

d. Integrated Data Processing (Data Access Middleware) Class

A class for accessing data in an integrated manner. It is assumed that not only measured data but other types of data (for example, calculation formula data, input data, diagnostic data, and statistical data) can be generally processed. This class must be used when accessing measured data and the various kinds of data shown in 3.4.1. In addition to obviously not directly accessing data files, a data variable in a channel class is also not directly referenced.

### Type of Data

(1) Measured data
(2) Calculation formula data
(3) Input data
(4) Diagnostic data
(5) Statistical data

It is assumed that a data number and an item ID are set in each data type.

By enabling access via an interface commonalized by the present middleware instead of having each application server 5 directly access a database, not only can destruction of data and unauthorized access can be prevented but all applications become capable of accessing data by a common method.

### Class Design

Although originally in Tchannel, a data acquisition function is taken out and made a new independent class.
Data is made acquirable with various parameters.
Data of all data types can be acquired in an almost automatic manner by only an item ID.
When a time of day is not designated, data of a time of day shown by Tchannel.time (data stored in Tch_.data) is obtained (normally, a time of day and data of a latest value are stored).
Data with appetizers can be acquired using item ID 2.

### Class Design

//integrated data processing (data access middleware) class definition

class Tdata {

enum data_type {DATATYPE_CH, DATATYPE_CAL, DATATYPE_INPUT, DATATYPE_DIAG, DATATYPE_TOKEI}};

//type of data: calculation formula data, calculation formula, input value, diagnostic value, statistical value

double get_data (Tkomoku_ID komoku_ID)//acquire data according to item ID class

double get_data (Tkomoku_ID komoku_ID, Ttime time)//acquire data according to item ID

class and time of day

bool get_data (Tkomoku_ID komoku_ID, Ttime time_s, Ttime time_e, double *data)

//acquire data according to item ID class and data in a time of day range

bool get_data (Tkomoku_ID komoku_ID, Ttime time, int kosu, double *data)

//acquire designated number of pieces of data according to item ID class and time of day

double get_data (int data_type, int no)//acquire according to data type and data number

};;
A latest value is assumed when no time of day is designated.
A data acquisition function for a large amount of data is also conceivable.

### Second Embodiment [System Configuration Example]

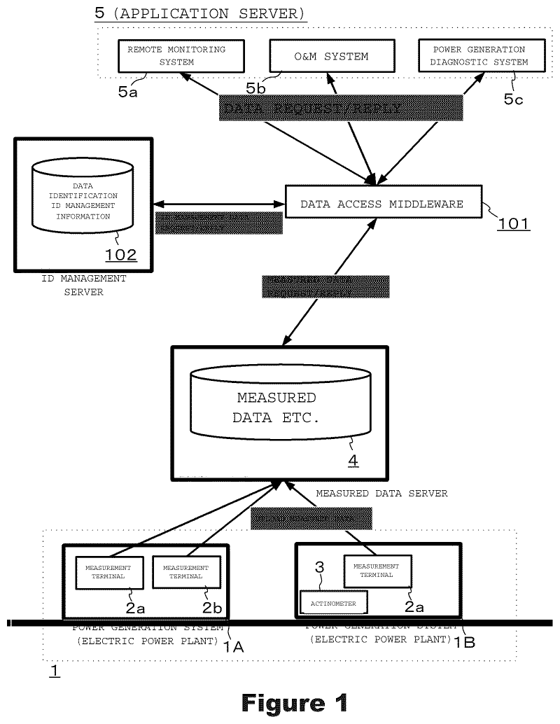

FIG. 1 is a diagram showing a configuration example in which a data identification ID described in the first embodiment is applied to a power generation system as a specific application example of the data identification ID.

The system is configured such that a power generation system 1 and a measured data server 4 are connected through a network and, further, various application systems 5 (5a to 5c) and the measured data server 4 are connected via data access middleware 102. Furthermore, an ID management server 101 for managing data identification IDs is provided and transmission and reception of necessary ID management data can be performed by communicating with the data access middleware 102.

Measurement terminals 2 (2a and 2b) acquire various kinds of from a PCS and are connected to the measured data server 4 via a telecommunication line such as the Internet. Measured data at various points are collected at the measured data server 4. The data server 4 is a server for managing a database of measured data or the like and the database itself may have a data structure unchanged from a conventional data structure constituted of a timestamp associated with an identifier specifying a power generation system (electric power plant) and a plurality of numerical strings associated with the timestamp.

Power generation systems 1 (1A and 1B) are units constituting electric power plants scattered at various locations and may vary depending on scale of the electric power plants. For example, while the power generation system 1A is assumed to have a plurality of measurement terminals 2 (2a, 2b, . . . ), the power generation system 1B is assumed to include an actinometer 3 in addition to the plurality of measurement terminals 2 (2a, 2b, . . . ). A power generation control apparatus called a PCS, a power generation control apparatus for controlling the PCS (both not illustrated), and the like are connected to the measurement terminal 2 and a power generation apparatus (for example, a panel for photovoltaic power generation) is connected to the PCS.

However, a type of the power generation apparatus is not particularly limited and need only be a power generation apparatus requiring a power generation amount to be controlled. For example, power generation apparatuses using wind power, geothermal heat, hydraulic power, and other various formed of natural energy besides sunlight are conceivable. Since such power generation apparatuses encompass elements that may fluctuate due to weather conditions and the like, there is a strong need to monitor a state of devices in each system and to detect faults or signs of faults of such devices.

The various application servers 5 (5a to 5c) provide various services by utilizing various pieces of measured data stored in the measured data server 4. For example, there is a remote monitoring system 5a for diagnosing an operation state or the like of a power generation system at a remote location, an O&M (operation and maintenance) system 5b for checking an operation state and performing maintenance, and a power generation diagnostic system 5c for diagnosing an error or a fault, age-related degradation, and the like of the devices in the power generation system.

Conventional power generation systems had adopted a configuration where the application server 5 directly accesses the measured data server 4 and issues requests and sends replies with respect to data. However, in a configuration where each application server 5 directly accesses a database, there is risk that the database recorded on the measured data server 4 may be destroyed by access concentration of a database server, an error in a program executed on each application server 5, and other unforeseen circumstances. Alternatively, a risk that the application server 5 becomes a stepping stone for unauthorized access to the measurement database server 4 may increase.

In order to avoid such problems, in the present embodiment, a configuration where the data access middleware 102 is interposed between the measured data server 4 and the application server 5 is adopted and requests and replies with respect to management data to the data access middleware 102 are managed by the ID management server 101 for uniquely specifying measured data of power generation systems scattered at various locations and various pieces of data accompanying the measured data.

The ID management server 101 is a server for managing data identification IDs and enables, even if there are a plurality of measurement terminals, data to be uniquely identified independent of the measurement terminals. The data access middleware 102 can run on any of the servers or on the measurement terminal 2a.

According to such a configuration, by having each application server 5 access the measurement database 4 via an interface commonalized by the data access middleware 102, risks of destruction of data in the measured data server 4 and unauthorized access to the measured data server 4 can be reduced.

The data access middleware 102 has a function of receiving a request from the application system 5 and sending back necessary data. Therefore, a relationship between ID management information for data identification and measured data must be registered in advance in the ID management server 101. The registration need not necessarily be performed by the data access middleware 102 itself and is realized by inputting necessary information to the ID management server 101 in advance.

The ID management server 101 manages a database of data identification IDs and stores a table for giving meaning to numerical strings included in the database (table) recorded on the measured data server 4. Therefore, the data access middleware 102 has a function of responding with specific ID management data corresponding to necessary data in accordance with a request from the data access middleware 102.

A method of implementing the data access middleware 102 is not limited and a configuration may be adopted where the data access middleware 102 runs on a dedicated stand-alone server connected to a network. For example, although not essential, data access middleware may be implemented as a web application on a web server. In this case, a configuration may be adopted where a data request is issued from the application server 5 as a URL created by adding a specific command or data to a domain of a server or the like.

Alternatively, in a simpler system, a similar function may be internally mounted to one or a plurality of measurement terminals 2 in the power generation system 1.

Measured data recorded on the measured data server 4 is a collection of numerical data representable as a table constituted of a timestamp and a plurality of pieces of numerical data at a time of day of the timestamp and, normally, such numerical values are recorded for each power generation system (electric power plant). Measured data can be made distinguishable by setting, in advance, which measurement terminal of which power generation system or measurement site the measured data had been uploaded from. In addition, a correspondence between each piece of data in numerical data to an identification ID is set in advance. An order of numerical data remains unchanged unless settings of the measurement terminal are changed. Conversely, when the settings of the measurement terminal are to be changed, settings of the ID management server 101 must also be changed.

Next, an operation of the data access middleware 102 will be described. The application system 5 requiring data attaches an identification ID to requested measured data and sends a request to the data access middleware 102. In response to the request, the data access middleware 102 accesses the measured data server 4, reads necessary data, and sends back the data to the application system 5. For example, the following format is conceivable as a data request to be transmitted from the application system 5 to the data access middleware 102.

Electric power plant ID: 123456 (Laplace Electric Power Plant)

Measurement system ID: 789 (Measurement System 1)

Item ID: 10 (AC power of PCS1)

Request period: Feb. 1, 2022

By providing the identification ID described above and accessing the data access middleware 102, querying an ID management server enables a request for data on Feb. 1, 2022 among AC power of a first PCS of the measurement system 1 of Laplace Electric Power Plant to be made. In addition, since an object record and an object location of the data recorded on the measured data server 4 can be found out from information having been registered in the ID management server in advance, the data access middleware 102 accesses the measured data server 4 to acquire necessary measured data and sends back the measured data to the application system 5.

The application system 5 can request data by providing a plurality of data identification IDs. For example, in addition to requesting a plurality of measurement items from a plurality of electric power plants, a plurality of periods' worth of data can be requested in terms of periods. A configuration may be adopted where the data access middleware 102 performs calculation of aggregate processing (for example, an average value or an accumulated value) of a designated period and sends back a result of the calculation.

### Utilization Example of Data Access Middleware

Advantages of using data access middleware will be described with reference to a case example.

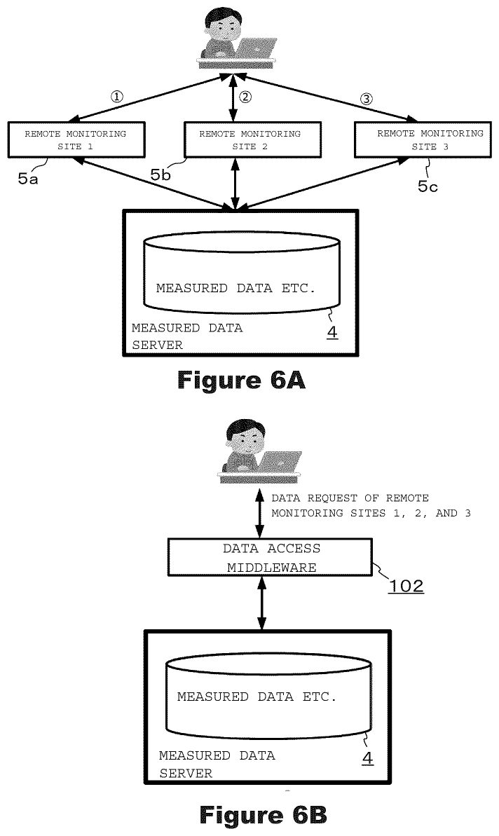

FIG. 6A is a configuration diagram of a case where the data access middleware 102 is not arranged and a user directly accesses the measured data server 4 via a plurality of remote monitoring sites 1 to 3. By comparison, FIG. 6B is a configuration diagram of a case where the measured data server 4 is accessed via data access middleware. A utilization example of data access middleware will be described through a comparison of the configuration diagrams.

First, as a premise, the data access middleware 102 requests specific data to be read with respect to a logical database constructed in a database server in which numerical data including a plurality of numerical values is recorded and a system is assumed to respond to the request.

The conventional configuration without the use of middleware (FIG. 6A) is a mechanism where a data read request is sent to the measurement database server 4 via the plurality of remote monitoring sites 5a to 5c and a reply of numerical data corresponding to the read request is received via each remote monitoring site. A meaning must be given to numerical data acquired from the measured data server 4 by the remote monitoring site or the meaning of the numerical data must be interpreted by the side having requested the data.

In contrast, in the configuration shown in FIG. 6B, all requests for numerical data are made via the data access middleware 102. As shown in FIG. 1, as a premise, the data access middleware 102 is capable of communicating with the ID management server 101 and giving “meaning” to numerical data recorded in the measurement database server 4 by associating an attribute or the like with the numerical data. In other words, the data access middleware is a program run in order to make a request for the numerical data to the measurement database server 4 and the data access middleware receives a read request for specific data included in the numerical data and reads the specific data from the measurement database server 4. In addition, the data access middleware acquires ID management data including a data identification ID uniquely identifying an attribute of numerical values constituting the numerical data from an ID management server recording such data identification IDs and replies to the read request in a state where attributes of the numerical values included in the specific data have been associated.

Case examples of applying the basic configuration described above to a mechanism for analyzing measured data of a photovoltaic power generation system will now be described. In this case, as shown in FIG. 1, the photovoltaic power generation system (electric power plant) is assumed to have a mechanism of uploading, to the measurement database server 4, measured data acquired from a measurement terminal or a measuring device installed in each photovoltaic power generation system (electric power plant).

### Case Example 1

When acquiring a same type of data (for example, an amount of generated electric power) from a plurality of electric power plants, instead of accessing each remote monitoring site as shown in FIG. 6A, processing can be performed with one request by involving middleware as shown in FIG. 6B. Being capable of acquiring data of a plurality of electric power plants in a crosscutting manner is useful for clients or O&M (operation and maintenance) companies who simultaneously monitor a plurality of electric power plants. For example, when realizing a function of displaying respective pieces of data of one's electric power plants as a list, all of the data can be acquired via the middleware even if the electric power plants are accessed via different communication media such as websites and application software running on smartphones.

### Case Example 2

A present-day power generation diagnostic function for diagnosing an error or a fault, age-related degradation, and the like of devices is individually implemented for each electric power plant. Therefore, the only possible diagnosis was by comparing with previous power generation data and the like accumulated in each electric power plant. However, utilizing data access middleware enables necessary data to be acquired from a plurality of electric power plants. Accordingly, the acquired data can be analyzed.

For example, by comparing different pieces of data of similar configurations in a crosscutting manner from a plurality of perspectives such as electric power plants being geographically close to each other, electric power plant with a same rated capacity, and electric power plants with similar device compositions, power generation diagnostics for detecting an error or a fault of devices can be performed.

### Case Example 3

While there are generally various types of data as described earlier, middleware for handling data managed as a “set of a data identification ID and data” is advantageous in terms of being able to unify handling regardless of the type of data. In other words, even when source data includes not only data of a given company but also data of another company, due to the middleware absorbing a difference in source data, an application of a client or a higher-order application need no longer be aware of the difference in source data and data becomes simpler and more readily understood by a data-requesting side.

While [Case example 1] to [Case example 3] described above using FIG. 6A and FIG. 6B all represent example of a user or a specific device issuing a request for measured data to the measured data server 4 for recording “measured data” and receiving a reply of the requested measured data (numerical data) via “middleware” with power generation analysis in a photovoltaic power generation system in mind, what is important is to first give meaning to numerical data by associating the numerical data and a data identification ID with each other and to respond with the requested numerical data. It is needless to say that the numerical data is not limited to measured data and includes all character strings and data handleable on a computer. Such a mechanism can be applied to a diagnostic system for detecting an error or a fault of devices.

### Second Embodiment-Communication Method of Data

When the application server 5 for handling data issues an access request for the measured data server 4 to the middleware 102, necessary data can be identified using a data identification ID. Therefore, the middleware 102 can quickly acquire necessary data from a database managed by the measured data server 4 and send back the data to the application server 5 from which the access request had been received.

While specific realization means is not necessarily limited to one, as an example, a method of using a so-called web API is conceivable. Generally, a web API is a web application program for additionally attaching an option (additional information) to a URL of an object server and communicating to be sent necessary data from the server. In the case of the above, a middleware server 101 as an object is started up as a web server, a URL of the middleware server 101 becomes an entrance of middleware, and an access request is made by adding information such as a data identification ID, a data period, and a data format as an option of the URL. Furthermore, an aspect is assumed where, due to settings in advance, a readily-handleable output format can be optionally selected for each application from a plurality of output formats including a binary format, a JSON format, and a CSV format.

An example of a photovoltaic power generation system will now be described once again. Conventionally, a measurement terminal connected to a power conditioner (PCS) in a photovoltaic power generation system must refer to a channel table and set a corresponding channel number when receiving generated electric power from the PCS and displaying the generated power. This is because data acquired from the PCS is simply a series of numerical values immediately after acquisition. Information describing which numerical value among numerical values arranged in order is what data (for example, a first numerical value is AC power of a first PCS) is defined by the channel table.

At an installation site of a PCS, the order often changes every time a PCS is additionally installed or communication specifications change and the channel table is often updated upon each of such changes. This is what causes trouble. Generally, orders seem to be depending on a communication protocol of the PCS.

In consideration thereof, by setting an identification ID of generated electric power (a physical quantity identification ID) instead of a channel table and always handling an identification ID and data corresponding to the identification ID as a pair, loss of meaning of data can be avoided even when an order of saving the data changes. For example, data representing generated electric power can be identified by using the identification ID as a mark regardless of the order of the data in the channel table. An order of saving data also need no longer be designated.

Similarly, when transmitting data by communication, an order of transmission becomes meaningless as long as a rule of always handing data and an identification ID as a pair is followed and data can be transmitted at any timing. In other words, a protocol needs no longer be designated.

Furthermore, channel numbers are only unique inside each measurement terminal. If there are a plurality of measurement terminals in one power generation system, overlapping may occur among channel numbers. In this regard, since a data identification ID can be assigned to a unique value in a same power generation system, unique data can be identified and acquired independent of a measurement terminal even if there are a plurality of measurement terminals.

Enabling only necessary data to be extracted independent of order as in the present embodiment contributes toward dramatically improving versatility of processing.

A data identification ID can also be applied to a calculation formula, an input value, a calculated value, and the like and calculated value and a measured value can be equally treated. In addition, as long as all sites follow a similar rule, uniform processing can be performed without being affected by a unique system format of each site. Hypothetically speaking, if all measurement systems in the whole world were to adopt this method, all of the pieces of data in the whole world can be handled in a versatile manner.

### Example 1

A system can be constructed where the application server 5 issues a request for generated electric power to each of a plurality of power generation systems 1 (1A, 1B, . . . ) and acquires a total value of the generated electric power. This may prove to be a significant advantage to users who manage a plurality of power generation systems.

In this regard, a conventional system required time for processing due to an application side having to issue a request for and acquire information of each power generation system and to aggregate the information. In addition, the advantage is significant considering the fact that there was a lot of waste in terms of communication since each request made to each power generation system required communication.

### Example 2

Let us assume a situation where there are two power generation systems 1A and 1B at locations relatively close to each other and a solar radiation sensor 3 is mounted to only one of the power generation systems (for example, the power generation system 1B). Since the solar radiation sensor 3 is expansive, it is often unrealistic to mount the solar radiation sensor 3 to all electric power plants. However, since the solar radiation sensor 3 is useful in predicting an amount of generated power and performing maintenance, preferably, data of the solar radiation sensor can be similarly utilized in predicting an amount of generated power and performing maintenance even with respect to power generation system not mounted with the solar radiation sensor. While it was not easy to conventionally utilize data outside of a power generation system as data of another power generation system, issuing a request for the data using an identification ID enables acquisition of data exceeding units of power generation systems and a width of data utilization to be expanded.

Examples of data identification IDs focused on measurement systems have been described in the first and second embodiments described with reference to FIG. 1. However, what is most essential is that every single piece of data in a “database” managed by a data server is uniquely identified by a “data identification ID” and, accordingly, given a meaning. While the use of an “ID management server” separate from a “data server” to manage data identification IDs and accessing the “data server” via “data access middleware” represent one of most rational aspects as a specific configuration example, other configurations are also conceivable such as including the function of the ID management server in a part of a measured data server, omitting a middleware server, and consolidating and simplifying a plurality of servers depending on a scale of data to be handled.

### Third Embodiment

The essence of the present invention is valid regardless of a type of data to be handled. What is important is to access a database via data access middleware while separating the database from an ID management server for managing data identification IDs. Therefore numerical data to be handled may include numerical values other than physical quantities such as sales, profit, and other monetary data.

For example, conventionally, it was common practice to refer to accounting information such as sales and profit only inside specific systems such as financial accounting systems. However, by providing an ID management server for managing data identification IDs separately from a database server and accessing a database via data access middleware, data reference not bound by a specific system can be performed and it becomes easier to collaborate between systems. For example, while numerical data such as sales and profit is sometimes required outside of financial systems since the numerical data can also be used for business analysis of the present and profit planning for the future but was inconvenient given that only necessary data must be output and used as a separate file or the like, managing the numerical data as data assigned a data identification ID in advance enables a system requiring the data to immediately refer to the data by issuing a request and very high convenience can be provided.

### Industrial Applicability

With the increasingly widespread use of IoT devices, while versatile handling of numerical data acquired by the IoT devices will remain impossible as long as numerical data is defined according to specifications unique to each company or defined for each location (site), having each company transmit and receive numerical data according to similar communication rules premised on the data structure according to the present invention enables the numerical data to be handled in a similar manner among different devices just like IP addresses or QR codes (registered trademark) and achieves extremely high industrial applicability.

1. A numerical value management system using a pair of logical data structures comprising:
a database constructed in a database server in which numerical data having a plurality of numerical strings associated with a timestamp is recorded; and
a data identification ID recorded in an ID management server physically or logically separated from the database, the data identification ID uniquely identifying an attribute of numerical values constituting the numerical data, middleware, and an application for requesting the numerical data with respect to the database via the middleware, wherein the data identification ID includes:
a unit ID constituted of a character string of at least two bytes defining a unit of the numerical data; and
an item ID of at least four bytes and made up of an item number, the item number being constituted of an integer value of at least two bytes for uniquely identifying a type ID of at least two bytes for defining a type of the numerical data and for uniquely identifying the type ID, and the type ID,
the unit ID being associated with a name and a unit character string,
the type ID including at least a character string corresponding to each type ID and the unit ID,
the pair of logical data structures are constructed by transmitting the data identification ID to the ID management server via the middleware and transmitting the timestamp and the numerical data corresponding to the timestamp to the database server,
the numerical data includes measured value data acquired by a measuring instrument and calculated value data calculated based on the measured value data,
the data identification ID is attached to both the measured value data and the calculated value data constituting the numerical data, and
the application acquires the measured value data and/or the calculated value data included in the numerical data from the database via the middleware by attaching the data identification ID to the middleware and requesting the numerical data.

2. The numerical value management system according to claim 1, wherein the middleware is executed in a measurement terminal for acquiring the numerical data.

3. The numerical value management system according to claim 2, wherein the middleware is executed in a middleware server being physically or logically independent of the measurement terminal.

4. The numerical value management system according to claim 1, wherein the middleware is executed in a web server and necessary information is sent back from the web server being an object by using a Web API to receive a read request to which additional information including the data identification ID has been attached with respect to a URL of the web server.

5. The numerical value management system according to claim 1, applied to a power generation system including a power conditioner and a device connected to the power conditioner, wherein
by using the data identification ID,
physical meaning of the numerical data is identified without having to depend on a communication protocol of the power conditioner.

6. The numerical value management system according to claim 5, wherein the numerical data includes measured data acquired from devices installed at a plurality of the power generation systems.

7. The value management system according to claim 6, wherein one of the plurality of numerical strings is data representing an amount of solar radiation acquired particularly by the power generation system including an actinometer among the plurality of the power generation systems, and by using the data identification ID, the data representing the amount of solar radiation is utilized to predict an amount of generated power in power generation systems other than the power generation system and/or to perform maintenance of power generation systems other than the power generation system.

8. The numerical value management system according to claim 7, wherein an application server executing the application detects an abnormality, a failure, or age-related degradation of the device in the power generation system based on the numerical data.

9. The numerical value management system according to claim 7, wherein an application server executing the application issues a request for specific data in the numerical data acquired in the plurality of the power generation systems and acquires a total value of the specific data.

10. The numerical value management system according to claim 2, applied to a power generation system including a power conditioner and a device connected to the power conditioner, wherein
by using the data identification ID,
a physical meaning of the numerical data is identified without having to depend on a communication protocol of the power conditioner.

11. The numerical value management system according to claim 3, applied to a power generation system including a power conditioner and a device connected to the power conditioner, wherein
by using the data identification ID,
a physical meaning of the numerical data is identified without having to depend on a communication protocol of the power conditioner.

12. The numerical value management system according to claim 4, applied to a power generation system including a power conditioner and a device connected to the power conditioner, wherein
by using the data identification ID,
a physical meaning of the numerical data is identified without having to depend on a communication protocol of the power conditioner.
